(19) United States
(12) Patent Application Publication
(10) Pub. No.: US 2023/0018577 A1
(43) Pub. Date: Jan. 19, 2023

(54) ELECTRIC VEHICLE CHARGING STATION CABINET

(71) Applicant: Christopher Naychuk, Vancouver, CA (US)

(72) Inventor: Christopher Naychuk, Vancouver, CA (US)

(21) Appl. No.: 17/305,977

(22) Filed: Jul. 19, 2021

(51) Int. Cl. B60L 53/16; B60L 53/18; H02G 11/02

(52) U.S. Cl. CPC B60L 53/16; B60L 53/18; H02G 11/02

(57) ABSTRACT

An electric vehicle charging station that is configured to be mounted in alternate locations on a residential structure and provide standardization of electrical coupling to all types of electric vehicles. The present invention includes a base cabinet having a plurality of walls and a bottom integrally formed to create an interior volume. A cable reel is rotatably mounted within the interior volume of the base cabinet wherein the cable reel further includes an axle. The axle is configured with an electrical coupling that is configured to couple to an end of an electrical cord suitable for charging an electric vehicle. A controller is electrically coupled to the axle and is further electrically coupled to a power source within the residential structure. The base cabinet is provided with an access port and a plurality of roller adjacent thereto for improved cable retraction or deployment.

### FIELD OF THE INVENTION

The present invention relates generally to electric vehicle support equipment, more specifically but not by way of limitation, an electric vehicle charging cabinet with integrated cable reel that is standardized so as to accommodate all types of electric vehicles and further facilitate an improved installation thereof in residential structures.

### BACKGROUND

As alternative energy sources are continuously developed the sales of electric vehicles has risen dramatically. Current technology in electric vehicles and the capabilities thereof has resulted in the rise in market penetration for consumer vehicles. More and more consumers are adopting utilization of electric vehicle as their capabilities increase as well as for the reduced impact on the environment. Sales of electric vehicles globally exceeded over two million units. Electric vehicles now account for almost three percent of automobile sales globally. As the electric vehicle sales expands the infrastructure required to support these types of automobiles is also expanding. Charging stations are now being installed by most municipalities so as to facilitate the ability for users of electric vehicles to extend the use of their electric vehicle.

There are approximately seven and a half million charging stations worldwide with about six and a half million of these being private light duty charging stations that are in residential structures such as but not limited to single family homes and multi-family structures. As more electric vehicles are purchased by consumers, the demand for in-home charging stations will increase. Currently, existing methods for installation of charging stations lack standardization and can be quite expensive. Furthermore, the use of current charging stations can be cumbersome as cord management can be challenging.

It is intended within the scope of the present invention to provide an electric vehicle charging station having a standardized base cabinet being configured to accommodate all types of electric vehicles wherein the present invention further provides improved cord management and mounting capabilities.

### SUMMARY OF THE INVENTION

It is the object of the present invention to provide an electric vehicle charging station configured to electrically couple to all types of electric vehicles wherein the electric vehicle charging station includes a grounded base cabinet wherein the base cabinet can be mounted in alternate locations on or adjacent to a structure.

Another object of the present invention is to provide a charging station for electric vehicles that is standardized in order to couple to all types of electric vehicles wherein the base cabinet of the present invention can be flush mounted within a wall, mounted adjacent to a wall or be mounted on a support post.

A further object of the present invention is to provide an electric vehicle charging station configured to electrically couple to all types of electric vehicles wherein the base cabinet of the present invention includes a lockable access door.

Still another object of the present invention is to provide a charging station for electric vehicles that is standardized in order to couple to all types of electric vehicles wherein the base cabinet of the present invention includes a cable reel that is rotatably mounted within the base cabinet and operable to facilitate deployment and retraction of an electrical cable.

An additional object of the present invention is to provide an electric vehicle charging station configured to electrically couple to all types of electric vehicles wherein the cable reel includes an incorporated universal electrical socket that is configured to electrically couple to all untethered electric vehicle cables.

Yet a further object of the present invention is to provide a charging station for electric vehicles that is standardized in order to couple to all types of electric vehicles wherein the base cabinet can be installed in alternate orientations from flat to vertical with the cable reel extending through a wall to accommodate narrow profiles on walls such as those on opposing sides of residential garage doors.

Another object of the present invention is to a provide an electric vehicle charging station configured to electrically couple to all types of electric vehicles wherein the base cabinet further includes an access hatch for cord deployment while a cabinet door is in its closed position.

An alternate object of the present invention is to provide a charging station for electric vehicles that is standardized in order to couple to all types of electric vehicles wherein the base cabinet further includes a plurality of rollers disposed within the interior volume thereof adjacent to the access hatch.

Another object of the present invention is to a provide an electric vehicle charging station configured to electrically couple to all types of electric vehicles that includes a dual sided controller having operational interfaces on opposing sides so as to access from inside and/or outside the structure.

An alternate object of the present invention is to provide a charging station for electric vehicles that is standardized in order to couple to all types of electric vehicles wherein the controller is standardized in terms of mounting to and within the cabinet in order to be interchangeable for alternate OEM vehicles.

Another object of the present invention is to a provide an electric vehicle charging station configured to electrically couple to all types of electric vehicles wherein the cabinet is configured to allow the electrical cable to be dispensed from opposing sides thereof in order to allow utilization thereof both inside and outside of the structure.

An alternate object of the present invention is to provide a charging station for electric vehicles that is standardized in order to couple to all types of electric vehicles that further includes a lockable door so when the electrical cable is deployed it cannot be untethered/unplugged from the coil.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of an exemplary structure for mounting the present invention and exemplary mounting locations; and

FIG. 2 is a front view of an embodiment of the present invention; and

FIG. 3 is a side view of an embodiment of the present invention; and

FIG. 4 is a front view of an embodiment of the present invention; and

FIG. 5 is a side view of a post mount embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an electric vehicle charging cabinet 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

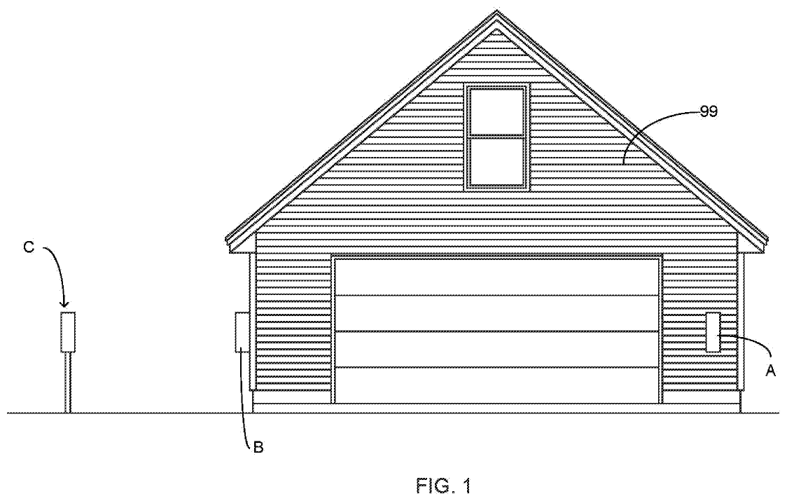

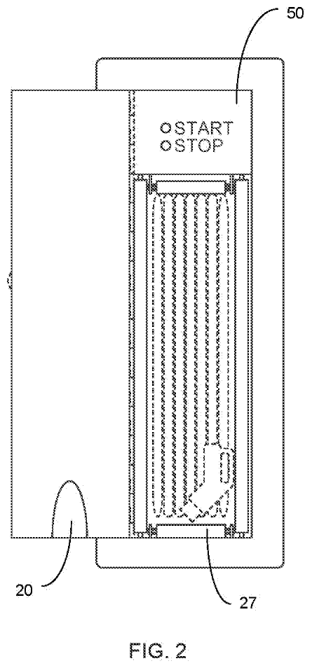

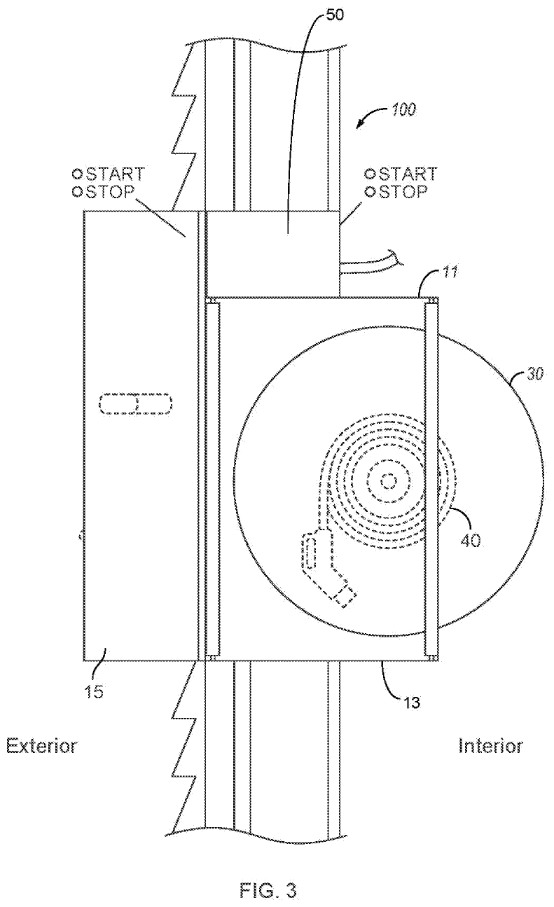

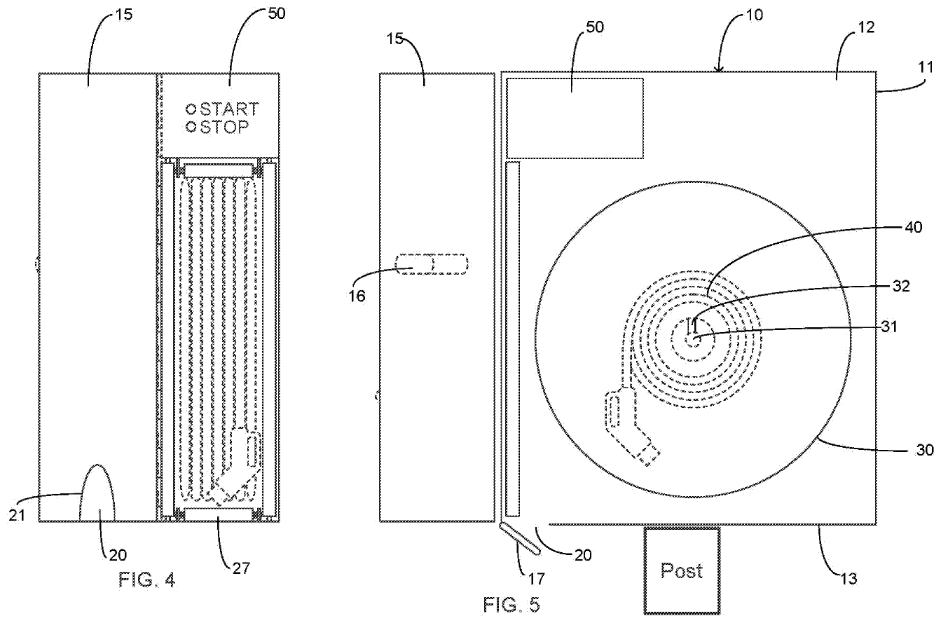

Now referring in particular to the Figures submitted as a part hereof, the electric vehicle charging cabinet 100 is provided in embodiments to facilitate the mounting thereof in various locations on a structure. FIG. 1 illustrates exemplary mounting locations A, B and C wherein the aforementioned locations are in alternate positions on an exemplary single family house 99. It should be understood within the scope of the present invention that these mounting locations are exemplary and do not exclude alternate locations not illustrated herein such as but not limited to an interior wall within a garage. The electric vehicle charging cabinet 100 is configured to be electrically coupled to conventional power supplies of a structure and is further configured to be capable of receiving electrical service rated within forty to one hundred amps. It should be understood within the scope of the present invention that the electric vehicle charging cabinet 100 is conventionally wired to an electrical panel and could be wired so as to be rated for alternate amperage capacities as needed.

The electric vehicle charging cabinet 100 includes a base cabinet 10. The base cabinet 10 is manufactured from a durable weatherproof material such as but not limited to metal or plastic. The base cabinet 10 is comprised of a plurality of walls 11 and a bottom 13 being integrally formed to create an interior volume 12. The base cabinet 10 of the present invention is provided in alternate sizes and shapes that is dependent upon the mounting location. A mounting location for the base cabinet 10 that is flush mounted within a wall during construction of a home can be provided in a different size that a base cabinet 10 that may be mounted to an exterior surface or on a post. It should be understood within the scope of the present invention that the base cabinet 10 could be sized in order to accommodate a cable reel 30 of various lengths and diameters that will be sufficient in order to deploy and electrically couple to an electric vehicle.

The base cabinet 10 includes a door 15. The door 15 is hingedly coupled to the base cabinet 10 utilizing suitable fasteners and is movable between an open and closed position. The door 15 includes lock 16 wherein the lock 16 is a conventional lock that is operable to inhibit access to the interior volume 12 so as to prevent theft of elements disposed therein. The door 15 further includes an access port 20. The access port 20 is an opening in the door 15 that includes a peripheral edge 21 to form a half-oval shape of the access port 20. The access port 20 is operable to facilitate deployment of the electrical cord 40 while the door 15 is in a closed position. It should be understood within the scope of the present invention that the access port 20 could be provided in alternate sizes in order to accommodate different sized electrical cords 40. An alternate location for the access port 20 is illustrated in FIG. 5 wherein the access port 20 is formed in the bottom 13 of the base cabinet 10. This mounting location can be further provided with a hinged cover 17. Disposed within the interior volume 12 of the base cabinet 10 adjacent to the access port 20 are rollers 27. The rollers 27 are rotatably mounted within the interior volume 12 of the base cabinet 10 utilizing suitable fasteners. Rollers 27 are manufactured from a material such as but not limited to rubber and are provided to assist in the deployment and retraction of the electrical cord 40. It should be understood within the scope of the present invention that the rollers 27 could be positioned in alternate locations within the interior volume 12 of the base cabinet 10 in order to assist in the smooth deployment and retraction of the electrical cord 40.

The electrical cord 40 is operably mounted to the cable reel 30. The cable reel 30 is rotatably mounted within the interior volume 12 of the base cabinet 10. The cable reel 30 includes axle 31 that is configured to provide rotational movement of the cable reel 30. Axle 31 includes electrical connection 32 wherein the electrical connection 32 is a standardized electrical coupling that is configured to be operably coupled to an end of the electrical cord 40. The electrical connection 32 is electrically coupled to controller 50 wherein the controller 50 is electrically coupled to the power supply of the structure in which the electric vehicle charging cabinet 100 is mounted. The aforementioned configuration of the electrical connection 32 on the axle 31 allows for rotational movement of the cable reel 30 to deploy electrical cord 40 while maintaining the necessary electrical coupling. It is additionally contemplated within the scope of the present invention that the cable reel 30 could employ a motor to provide movement thereof or alternatively utilize a spring bias to assist in the retraction of the electrical cord 40 subsequent deployment.

The controller 50 is mounted within the base cabinet 10 and includes the necessary electronics to receive, store, transmit and manipulate data and further provide electrical power distribution to the cable reel 30. It is contemplated within the scope of the present invention that the controller 50 can be a vehicle specific module and as such be interchangeable to accommodate an alternate vehicle. It is further contemplated within the scope of the present invention that the controller 50 could be wirelessly couple to a remote device such as but not limited to a smart phone wherein the smart phone could employ a software application so as to provide operational interface with the controller 50.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. An electric vehicle charging station configured to be mounted in alternate locations within or adjacent to a residential structure wherein the electric vehicle charging station comprises:
a base cabinet, said base cabinet having a plurality of walls and a bottom integrally formed to create an interior volume, said base cabinet having a door, said door being hingedly secured to said base cabinet covering an opening thereof, said base cabinet being constructed to be mounted in at least two different locations;
a cable reel, said cable reel being disposed within said interior volume of said base cabinet, said cable reel being configured to receive an electrical cord, said cable reel having an axle, said cable reel being rotatably mounted via said axle; and
an electrical coupling, said electrical coupling being formed in said axle, said electrical coupling operable to electrically couple to an end of the electrical cord, wherein the electrical cord is suitable to be operably coupled to an electric vehicle for charging thereof.

2. The electric vehicle charging station as recited in claim 1, and further including a controller, said controller being mounted within said base cabinet, said controller being electrically coupled to said axle, said controller further being electrically coupled to a power source within the residential structure.

3. The electric vehicle charging station as recited in claim 2, and further including an access port, said access portion being formed in said base cabinet in either a first location or a second location.

4. The electric vehicle charging station as recited in claim 3, wherein the first location for the access port is in said door, wherein said access port has an opening of sufficient size to have the electrical cord pass therethrough while the door is in a closed position.

5. The electric vehicle charging station as recited in claim 4, and further including a plurality of rollers, said plurality of rollers being mounted within the interior volume of said base cabinet, said rollers being adjacent said access port.

6. The electric vehicle charging station as recited in claim 5, wherein said second location of said access port is in said bottom of said base cabinet, said second location of said access port further having a hinged cover.

7. The electric vehicle charging station as recited in claim 6, wherein the controller includes necessary electronics to receive, store, manipulate and transmit data, said controller being interchangeable to accommodate alternate types of electric vehicles.

8. The electric vehicle charging station as recited in claim 7, wherein the electric vehicle charging station is rated for forty to one hundred amps.

9. The electric vehicle charging station as recited in claim 8, wherein the cable reel can be operably rotated either manually or with a motor.

10. An electric vehicle charging station configured to facilitate deployment of an electrical cord and further being configured to standardize electrical connections for coupling of an electrical vehicle wherein the electric vehicle charging station comprises:
a base cabinet, said base cabinet having a plurality of walls and a bottom integrally formed to create an interior volume, said base cabinet having a door, said door being hingedly secured to said base cabinet covering an opening thereof, said base cabinet being constructed to be mounted alternate locations;
a cable reel, said cable reel being disposed within said interior volume of said base cabinet, said cable reel having an axle, said cable reel being rotatably mounted via said axle, wherein rotation of the cable reel facilitates either deployment or retraction of an electrical cord, said electrical cord being operably coupled to said axle;
an electrical coupling, said electrical coupling being formed in said axle, said electrical coupling operable to electrically couple to an end of the electrical cord, wherein the electrical cord is suitable to be operably coupled to an electric vehicle for charging thereof; and
a controller, said controller being mounted within said base cabinet, said controller being electrically coupled to said axle, said controller further being electrically coupled to a power source within the residential structure, wherein the controller includes necessary electronics to receive, store, manipulate and transmit data, said controller being interchangeable to accommodate alternate types of electric vehicles.

11. The electric vehicle charging station as recited in claim 10, and further including an access port, said access portion being formed in said base cabinet in either a first location or a second location, wherein said second location of said access port is in said bottom of said base cabinet, said second location of said access port further having a hinged cover.

12. The electric vehicle charging station as recited in claim 11, and further including a plurality of rollers, said plurality of rollers being mounted within the interior volume of said base cabinet, said rollers being adjacent said access port.
